(19) United States
(12) Patent Application Publication
(10) Pub. No.: US 2026/0254084 A1
(43) Pub. Date: Aug. 27, 2026

(54) TUNABLE CERAMIC WAVEGUIDE FILTER

(71) Applicant: Telefonaktiebolaget LM Ericsson (publ), Stockholm (SE)

(72) Inventors: Jichuan Zhang, Stockholm (SE); Juandi Song, Beijing (CN); Hongyu Xu, Sollentuna (SE)

(21) Appl. No.: 19/162,235

(22) PCT Filed: Mar. 10, 2023
(86) PCT No.: PCT/CN2023/080667

§ 371 Date: Sep. 4, 2025

(51) Int. Cl. H01P 1/208; H01P 11/00

(52) U.S. Cl. CPC H01P 1/2088; H01P 11/002; H01P 11/007

(57) ABSTRACT

A ceramic radio frequency (RF) filter is provided, including a first ceramic block and a second ceramic block attached on top of the first ceramic block. One or more through-holes are provided through the first block, and one or more corresponding blind-holes are provided in the second block and at least partially aligned with the one or more through-holes of the first block. The filter further includes input and output terminals arranged at the first block, for injecting and extracting, respectively, a signal into/from the first block. A method of manufacturing the filter is also provide, including an optional step of performing a frequency-adjustment of the RF filter by adjusting a depth and/or size of at least one blind-hole.

### TECHNICAL FIELD

The present disclosure relates to waveguide filters for use in radio communication equipment. In particular, the present disclosure relates to a ceramic filter design which is tunable to account for material and manufacturing tolerances.

### BACKGROUND

To continue the evolution of radio systems, being able to increase performance while reducing the overall system-size may be desirable. A key part of many radio systems is the radio frequency (RF) filter, which may be incorporated e.g. in the system's front-end and used to select wanted frequencies while filtering out unwanted frequencies caused by spurious out-of-band emissions. To realize a more integrated and compact radio system, such as desirable in e.g. a cellphone or similar, it is thus desirable to make such RF filters both smaller in size and with a lower cost, while still maintaining high filtering performance.

Examples of currently available filter solutions include e.g. metal filters and ceramic waveguide (CWG) filters. Metal filters are known to provide good (unloaded) quality factors (Qu), good power handling, and can be manufactured using mature production processes. In order to reduce the size and weight of metal filters, various solutions have been proposed such as using sheet-metal bodies, semi-solid die-cast filter housings, lid-soldering, and similar. However, due to limitations of such mechanical processes, further reduction of the size and weight of metal filters has proven difficult.

Compared to metal filters, filters based on CWGs have smaller footprints, and are also easily integrated with the rest of the radio system using e.g. surface mount technology (SMT) processes. However, also compared to metal filters, CWGs suffer from worse spurious performance, and thus cause a need for high-performance low-pass filtering. With low-pass filters having sharp cut-off frequencies, insertion loss increases, and the usage of CWGs in radio systems is thus limited.

Other alternatives include so-called monoblock filters, wherein all components including filter and antenna elements are provided on a single board. Although such monoblock filters may offer smaller footprint, their Qu's are limited. Strong leakage is also common, and requires additional design considerations for the other parts surrounding the monoblock filter (s).

### SUMMARY

In light of the above-discussed disadvantages of currently available filters for radio systems, there is therefore a need for an improved filter design which allows for a small overall size, good performance, is easy to manufacture, and which may easily be tuned to account for material and manufacturing tolerances.

For this purpose, the present disclosure provides an improved ceramic radio frequency (RF) filter as well as a method for manufacturing of such a filter, as defined by the accompanying independent claims. Various embodiments of the improved filter and method are defined by the accompanying dependent claims.

According to a first aspect, there is provided a ceramic RF filter (hereinafter also referred to as just a “filter” or “ceramic filter”). The ceramic filter includes a first ceramic block with a top surface, a bottom surface, and side surfaces. The first ceramic block further has one or more resonance through-holes which extend through the first ceramic block from its top surface to its bottom surface. The first ceramic block is configured for being surface-mounted with its bottom surface to a printed circuit board (PCB). The ceramic filter further includes input and output terminals which are arranged at the first ceramic block, and which are configured for injecting and extracting (or at least for allowing such injecting and extracting when the filter is connected to other components on e.g. a printed circuit board), respectively, a signal into/from the first ceramic block. The ceramic filter further includes a second ceramic block. The second ceramic block has a top surface, a bottom surface, and side surfaces. The second ceramic block further has one or more blind-holes which extend only partially through the second ceramic block from its top surface towards its bottom surface (that is, the one or more blind-holes does not go all the way through the second ceramic block, and are visible only from the top surface but not from the bottom surface of the second ceramic block). The second ceramic block is attached on top of the first ceramic block, such that the bottom surface of the second ceramic block faces the top surface of the first ceramic block. Further, each one of the one or more blind-holes of the second ceramic is at least partially aligned with a corresponding one of the one or more through-holes of the first ceramic block.

As used herein, that a blind-hole and through-hole are “at least partially aligned” is to be understood as e.g. if the blind-hole of the second ceramic block was converted into a through-hole passing all the way through the second ceramic block from its top surface to its bottom surface, the alignment of the two holes would be such that it would be possible to see through both ceramic blocks via the holes, from e.g. the top surface of the second ceramic block to the bottom surface of the first ceramic block, without further e.g. widening any of the holes. Likewise, if the blind-hole and corresponding through-hole are to be considered as not “at least partially aligned”, the alignment would be such that converting the blind-hole to a through-hole would still not create any open path through both holes. For two holes having equal shapes (e.g., both holes being circular/cylindrical), “at least partially aligned” would of course also include the situation where the holes are concentric (i.e. “perfectly aligned”), or similar.

The ceramic filter according to the first aspect improves upon currently available technology in that the use of ceramic material offers a reduction in both size and weight while still maintaining performance. The envisaged ceramic filter is also easy to integrate with e.g. radios or antennas. By forming the ceramic filter from two ceramic blocks which is later attached together, the envisaged ceramic filter is also easier to manufacture compared to a monoblock design, as the through-holes of the first ceramic block are easier to form than if the holes were instead e.g. blind-holes extending from a bottom surface and partially towards a top surface of a single ceramic monoblock. As will be described later herein, such through-holes are also easier to metallize, and overall results in a reduced production cost, an increased production yield, and also allow for an improvement of consistency of density.

More in particular, the second ceramic block and the provision and alignment of the blind-holes therein allows to tune/adjust the resonance frequencies of the cavities formed by the through-holes of the first ceramic block. Such tuning can for example be achieved by adjusting the depth and size/diameter of the blind-holes, which may be performed by e.g. scraping or grinding of the bottom surface of the blind-holes. In addition, such tuning may be performed after assembly of the filter, and even after the filter has already been mounted to the PCB, which further enables a more convenient tuning process. By adjusting the dimensions of the blind-holes, differences in resonance frequencies between e.g. two or more through-holes caused by material and/or manufacturing tolerances can be accounted for and more easily controlled.

In one or more embodiments of the ceramic filter, at least the side surfaces and the one or more through-holes of the first ceramic block, and the top surface and side surfaces of the second ceramic block may be metallized, in order to assist in forming one or more resonances within the ceramic filter.

In one or more embodiments of the ceramic filter, the one or more blind holes of the second ceramic block may by at least partially metallized.

In one or more embodiments of the ceramic filter, the bottom surface of the second ceramic block may be attached to the top surface of the first ceramic block by any one of bonding, sintering and soldering. If using e.g. soldering to attach the surfaces, an at least partial metallization of the involved surfaces is preferably performed first.

In one or more embodiments of the ceramic filter, the ceramic filter may further include a metallization pattern on the top surface of the first ceramic block and/or on the bottom surface of the second ceramic block. Providing such a metallization pattern may help to extend an electric wavelength, and consequently cause a reduction of resonance-frequency.

In one or more embodiments of the ceramic filter, the size of each of the one or more blind-holes of the second ceramic block may match the size of the corresponding through-hole of the first ceramic block. Here, a “size of a hole” is e.g. (in case of circular holes) a diameter of the hole. If the holes are non-circular, such as e.g. oval, the size may instead refer to e.g. one or both of a semi-minor axis diameter and a semi-major axis diameter, or similar. If the holes are e.g. square, “size” may refer to the length of each of the sides of the square. If the holes are e.g. rectangular but not square, “size” may refer e.g. to the length of the longest sides of the rectangle. Matching the size of a blind-hole to its corresponding through-hole may e.g. help to increase the frequency-tunability.

In one or more embodiments of the ceramic filter, the size of at least one of the one or more through-holes of the first ceramic block may be non-uniform along the length of the hole.

In one or more embodiments of the ceramic filter, the first and second ceramic blocks may extend in a longitudinal direction, and include two or more through-holes and blind-holes, respectively. The two or more through-holes and blind-holes may be spaced along the longitudinal direction to form a plurality of resonators. Providing a plurality of such series-connected resonators may e.g. help to tailor a desired response characteristic of the ceramic filter.

According to a second aspect, there is also provided a method for manufacturing of a ceramic RF filter (such as the ceramic RF filter of the first aspect). The method includes, in a first ceramic block having a top surface, a bottom surface, and side surfaces, providing one or more resonance through-holes extending through the first ceramic block from its top surface to its bottom-surface. The method includes, in a second ceramic block having a top surface, a bottom surface, and side surfaces, providing one or more blind-holes extending only partially through the second ceramic block from its top surface towards (but not all the way to) its bottom surface. This is performed such that if the second ceramic block is attached on top of the first ceramic block with its bottom surface facing the top surface of the first ceramic block, each of the one or more blind-holes is at least partially aligned with a corresponding one of the one or more through-holes of the first ceramic block. The method further includes performing such an attaching of the second ceramic block on top of the first ceramic block.

In one or more embodiments of the method, the method may further include performing a frequency adjustment of the ceramic filter by adjusting a depth and/or size (such as e.g. a diameter in case of a circular hole) of at least one of the one or more blind-holes of the second ceramic block. This may be advantageous in that the tuning of the ceramic filter may be performed even with the ceramic filter already mounted to (and with the bottom surface of the first ceramic block facing) a printed circuit board (PCB).

In one or more embodiments of the method, adjusting the depth and/or size of at least one of the one or more blind-holes of the second ceramic block may be performed by e.g. scraping and/or grinding, or by any other means suitable to remove material in order to change the size of a blind-hole.

In one or more embodiments of the method, the frequency-adjustment of the ceramic filter may be performed after the first ceramic block has been surface-mounted with its bottom surface to a printed circuit board, as already mentioned above.

In one or more embodiments of the method, the method may further include performing a metallization of at least the side surfaces and the one or more through-holes of the first ceramic block, and at least the top surface and side surfaces of the second ceramic block.

In one or more embodiments of the method, the method may further include performing at least a partial metallization of the one or more blind-holes of the second ceramic block.

In one or more embodiments of the method, the attaching of the second ceramic block on top of the first ceramic block may include attaching the bottom surface of the second ceramic block to the top surface of the first ceramic block by any one of bonding, sintering and soldering. As mentioned earlier herein, if using soldering for such a process, it may be preferable to at least partially metallize the involved surfaces first.

Other objects and advantages of the present disclosure will be apparent from the following detailed description, the drawings and the claims. Within the scope of the present disclosure, it is envisaged that all features and advantages described with reference to e.g. the ceramic filter of the first aspect are relevant for, apply to, and may be used in combination with also the method of the second aspect, and vice versa.

### BRIEF DESCRIPTION OF THE DRAWINGS

Exemplifying embodiments will be described below with reference to the accompanying drawings, in which:

FIGS. 1A and 1B schematically illustrate, in exploded perspective views, a ceramic RF filter in accordance with embodiments of the present disclosure;

FIG. 1C schematically illustrates, in a sectional view, a ceramic RF filter in accordance with embodiments of the present disclosure;

FIG. 1D schematically illustrates, in a sectional view, a ceramic RF filter in accordance with embodiments of the present disclosure, wherein a metallization pattern is provided where the through-hole of the first ceramic block meets the bottom surface of the second ceramic block;

FIG. 1E schematically illustrates, in a sectional view, a ceramic RF filter in accordance with embodiments of the present disclosure, wherein a size of a through-hole is non-uniform along its length;

FIG. 1F schematically illustrates, in a sectional view, various measures which may be used to describe sizes and depths of a through-and blind-hole, respectively, of a ceramic filter in accordance with embodiments of the present disclosure;

FIG. 1G schematically illustrates, in a sectional view, a ceramic RF filter surface-mounted to a printed circuit board in accordance with embodiments of the present disclosure;

FIG. 2 schematically illustrates, in an exploded perspective view, a ceramic RF filter having multiple resonance through-holes and corresponding blind-holes, and surface-mounted to a printed circuit board, in accordance with embodiments of the present disclosure;

FIG. 3 schematically illustrates, in a sectional view, configurations of input and output terminals in a ceramic RF filter in accordance with embodiments of the present disclosure;

FIGS. 4A-4D schematically illustrate, in sectional views, various alternatives of metallization of surfaces of a ceramic RF filter in accordance with embodiments of the present disclosure;

FIG. 5 schematically illustrates, using a flowchart, various steps of a method for fabrication/manufacturing (and optionally tuning) of a ceramic RF filter in accordance with the present disclosure, and

FIG. 6 shows a plot of a simulation performed as a validation of a ceramic RF filter design in accordance with the present disclosure.

In the drawings, like reference numerals will be used for like elements unless stated otherwise. Unless explicitly stated to the contrary, the drawings show only such elements that are necessary to illustrate the example embodiments, while other elements, in the interest of clarity, may be omitted or merely suggested. If not stated to the contrary, the drawings are also not necessarily drawn to scale, and one or several dimensions may be exaggerated to highlight one or more particular features.

### DETAILED DESCRIPTION

Exemplifying embodiments of the envisaged ceramic RF filter (as well as a method for manufacturing and optionally tuning thereof) will now be described in more detail with reference to the Figures of the accompanying drawing, illustrating for example various envisaged configurations of filters and methods that fall within the scope of the accompanying patent claims. The drawings and the Figures thereon show only certain embodiments of the present disclosure. The envisaged invention of the present disclosure may, however, be embodied in many different forms and should not be construed as limited to the embodiments set forth herein; rather, the scope of the envisaged invention is defined by the accompanying patent claims, and the various embodiments illustrated in the drawings are provided only for thoroughness and completeness, and fully convey the scope of the invention of the present disclosure to the skilled person (as defined by the accompanying patent claims).

The present disclosure envisages an improved design of a ceramic RF filter, which allows for a small overall size, good performance, is easy to manufacture, and which may easily be tuned to account for material and manufacturing tolerances.

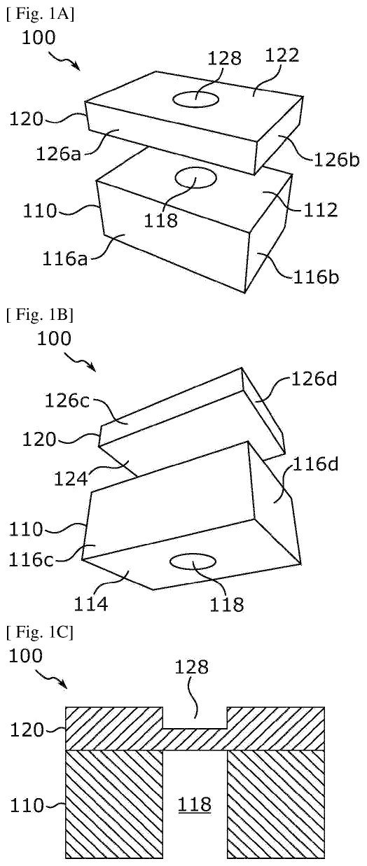

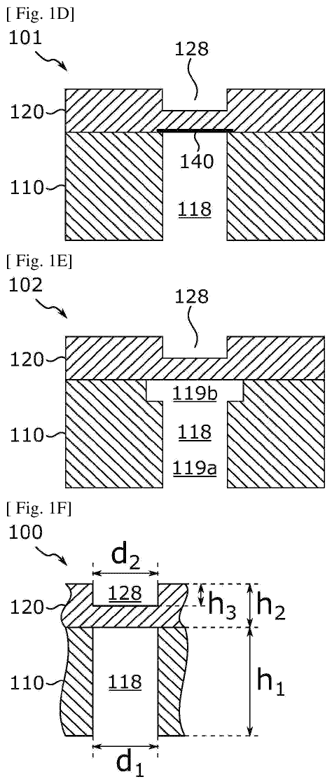

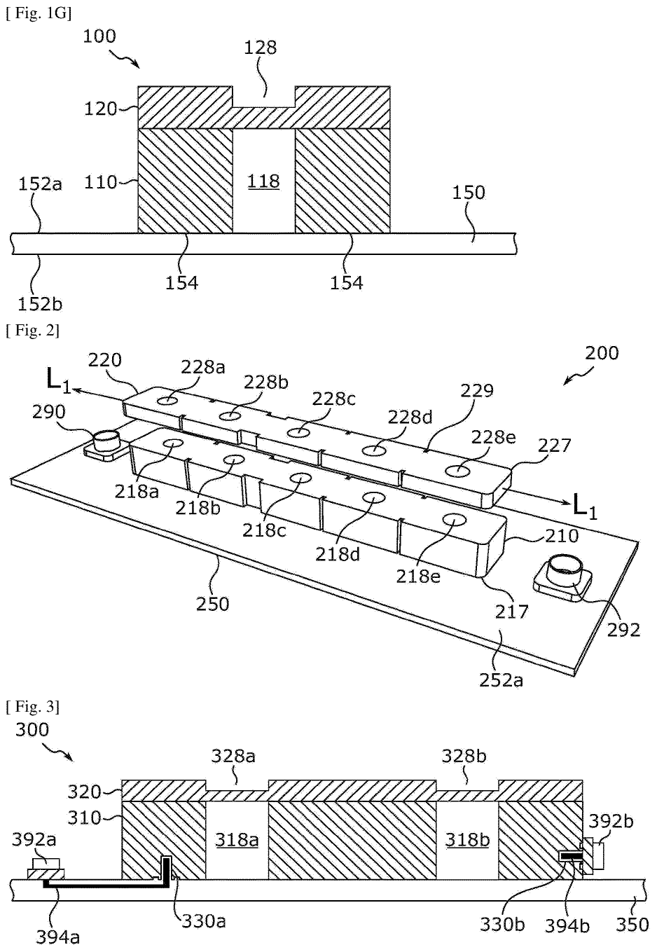

One embodiment of such a ceramic RF filter will now be described in more detail with reference to FIGS. 1A-1C.

FIGS. 1A and 1B schematically illustrate exploded views of a ceramic RF filter (hereinafter referred to as just “a/the filter”) 100, as seen from slightly above (FIG. 1A) and slightly below (FIG. 1B). The filter 100 includes a first ceramic block 110 and a second ceramic block 120 (also referred to as just “the first block” and “the second block”, respectively). The first and second blocks 110 and 120 are, in this embodiment, shaped as rectangular cuboids of matching sizes. The first block 112 has a top surface 112, a bottom surface 114, and four side/lateral surfaces 116a-d. Similarly, the second block 120 also has a top surface 122, a bottom surface 124, and four side/lateral surfaces 126a-d. When attached to each other, the first and second blocks 110 and 120 are configured such that the top surface 112 of the first block 110 faces the bottom surface 124 of the second block 120.

To create a resonance cavity in the filter 100, there is a through-hole 118 provided in the first block 110. The through-hole 118 extends through the first block 110 from the top surface 112 and all the way to the bottom surface 114.

To provide resonance frequency-tuning of the filter 100, there is also a blind-hole 128 provided in the second block 120. The blind-hole 128 does not extend all the way through the second block 120, but only from its/the top surface 122 and only partially towards its/the bottom surface 124 (as is shown in FIG. 1B). The blind-hole 128 may preferably be aligned with the through-hole 118. For example, if (as illustrated in FIGS. 1A and 1B) the through-and blind-holes 118 and 128 are both circular/cylindrical, the blind-hole 128 may be aligned with the through-hole 118 such that a longitudinal axis of the blind-hole 128 aligns with a longitudinal axis of the through-hole 118. Phrased differently, the blind-and through-holes 128 and 118 may be concentrically aligned. By aligning the blind-and through-holes 128 and 118 concentrically, it is envisaged that the frequency-adjustment range of the filter 100 can be optimized. In other embodiments, it is envisaged that there may also be some mis-alignment between the blind-and through-holes 128 and 118, such that the holes 128 and 118 are only partially aligned. However, even if being only partially aligned, it is still envisaged that there is at least some overlap of the blind-and through-holes 128 and 118. Phrased differently, if projecting the circumference of each hole 128 and 118 onto a plane perpendicular to e.g. the top surface 112 or the top surface 122, the two holes 128 and 118 are said to overlap if the projection areas of the holes 128 and 118 at least partially overlap on such a plane.

As will be discussed in more detail further below, it is also envisaged that in some embodiments of the filter 100, the blind-and through-holes 128 and 118 may have different shapes (e.g. circular/cylindrical, oval, square, rectangular, diamond-shaped, etc.). The holes 128 and 118 can be aligned such that their longitudinal axis (i.e. axis extending in a direction from the top surface to the bottom surface of the respective block 120 and 110) align, or such that their longitudinal axes are mis-aligned but not enough to remove any overlap of the holes as defined above.

As will also be discussed in more detail (with reference to e.g. FIG. 3), the filter 100 also has input and output terminals (not shown in FIGS. 1A and 1B), such that a signal may be injected in e.g. one end of the filter 100, filtered, and then extracted from e.g. another end of the filter 100.

In order to attach the first and second blocks 110 and 120 together, it is envisaged that e.g. bonding, sintering or soldering can be used. The first and second blocks 110 and 120 may be made from one or more ceramic materials, such as a fined dielectric ceramic having desirable properties such as high dielectric constant and low loss tangent. In some embodiments, both the first and second blocks 110 and 120 may be made from a same such material, while in other embodiments the material of each block may be different.

It is further envisaged that the filter 100 may be surface-mounted to a printed circuit board (PCB), such that the bottom surface 114 of the first block 110 faces towards the PCB. For example, the bottom surface 114 may include one or more metallized surfaces which can be used for soldering the filter 100 and the bottom surface 114 to the PCB. In other embodiments, such metal surfaces may also (or instead) be located e.g. on one or more of the side surfaces 116a-d of the first block 110, and sufficiently close to the bottom surface 114 for these surfaces to be used to solder the filter 100 and the first block 110 to the PCB. The metal surfaces used to solder the filter 100 and the first block 110 to the PCB may in any embodiment be used only to physically attach the filter 100 to the PCB, but may in some embodiments also be used for transferring signals (e.g. signals to be filtered) between the PCB and the filter 100.

FIG. 1C schematically illustrates a sectional view through the filter 100, for example if cut in the middle of the through-and blind-holes 118 and 128 along a cutting plane perpendicular to e.g. the side surface 116a of the first block 110. Such a cutting plane may e.g. be positioned in the middle between the side surfaces 116a and 116c of the first block 110. Here, it is seen how the through-hole 118 extends all the way through the first block 110, while the blind-hole 128 only extends partially through the second block 120. As can also be seen in FIG. 1C, in this particular embodiment, the through-and blind-holes 118 and 128 have a same size, which in the case of cylindrical/circular holes means that their diameters are the same (or at least approximately the same, such as with a deviation of a few percent or less, such as e.g. <1%, 1%, 2%, or similar). It can also be seen in FIG. 1C that the through-and blind-holes 118 and 128 are aligned concentrically, such that their longitudinal axes (not shown) align with each other. Further, in FIG. 1C, the various parts are not exploded, and instead shown in a configuration where the first and second blocks 110 and 120 are attached to each other as described earlier herein.

Other embodiments of a filter as envisaged herein will now be described in more detail with reference also to FIGS. 1D-G.

FIG. 1D schematically illustrates an embodiment of a filter 101 similar to the filter 100, but wherein a metallization pattern 140 is provided on the top surface of the first ceramic block 110 (or, e.g., on the bottom surface of the second block 120). The metallization pattern 140 has the effect that the surface length of the through-hole 118 is extended, which may serve both to e.g. achieve a lower resonance frequency of the filter 100. This may thus be obtained without e.g. using a material having a higher dielectric constant, and/or without having to increase the overall size of the filter 100 in order to achieve such a lower resonance frequency. In this and other embodiments using such metallization patterns 140 described herein, the metallization pattern 140 may e.g. be ring-formed (and extending in the interface-plane formed between the first and second blocks 110 and 120).

FIG. 1E schematically illustrates an embodiment of a filter 102 similar to e.g. the filter 100 or 101, but wherein a shape of the through-hole 118 is non-uniform along the length of the hole 118. In the particular embodiment shown in FIG. 1E, this is illustrated by the through-hole 118 having a lower section 119a and an upper section 119b (closer to or at the top surface of the first block 110), wherein a size/diameter of the through-hole 118 is larger at the upper section 119b than at the lower section 119a. Such a more complex shape of the first block 110 can also help to achieve an extended electric length (as “seen” by radio waves), and thus a lower resonance frequency than for a less complex shape such as that shown in e.g. FIG. 1C. In other embodiments, non-uniformity of the through-hole 118 may be obtained in other ways. For example, it is envisaged that the through-hole 118 may e.g. be conical, or similar, or have an even more complex shape than shown in FIG. 1E.

FIG. 1F schematically illustrates various parameters that may be introduced to define the “size” and “dimensions” of the through-and blind-holes 118 and 128. Preferably, for circular/cylindrical holes, the “size” of a hole may refer to a diameter of the hole, such as the diameter d₁ for the through-hole 118 and the diameter d₂ of the blind-hole 128. Likewise, a “length” of a hole may be defined as the extension/height h₁ of the through-hole 118, and the extension/height h₃ of the blind-hole 128. As the hole 118 is a through-hole, the parameter h₁ corresponds to the total height/thickness of the first block 110. As the hole 128 is a blind-hole, the parameter h₃ does not correspond to the total (but only a fraction of the) height/thickness h₂ of the second block 120. It is envisaged that in some embodiments, the sizes/diameters of the through-and blind-holes 118 and 128 may be equal, while in other embodiments the sizes/diameters of the through-and blind-holes 118 and 128 may be different, even if both holes 118 and 128 are still aligned or at least partially aligned with each other. For example, the blind-hole 128 may have a larger diameter than that of the through-hole, or vice versa. If the through-hole 118 is non-uniform along the length/height of the hole, additional parameters may be introduced, describing e.g. (if using the filter 102 shown in FIG. 1E as an example) a height and diameter of the upper section 119b, and also parameters describing e.g. a height and diameter the lower section 119a, of the through-hole 118, and similar. The blind-hole 128 may e.g. have a diameter which matches that of the diameter of the upper section 119b, which is smaller than that of the diameter of the upper section 119b, or which is larger than that of the diameter of the upper section 119b. In summary, it is envisaged that the amount of frequency tuning available can be tailored by varying the shape, size (e.g. diameter) and also height (or depth) of the blind-hole 128.

FIG. 1G schematically illustrates a situation wherein the filter 100 has been mounted to a PCB 150. The PCB has a top surface 152a and a bottom surface 152b, and the first block 110 is arranged such that its bottom surface faces the top surface 152a of the PCB 150, thus creating an interface 154 between the filter 100 and the PCB 150. As described earlier, such an interface 154 may be only to physically/mechanically attach the PCB 150 and filter 100 together, but may also serve as a means to transfer signals between the PCB 150 and filter 100.

In particular, FIG. 1G illustrates how the resonance frequency of the first block 110 and thereby of the filter 100 as a whole can be easily adjusted even after the filter 100 has been mounted to the PCB 150. This because while the filter 100 is mounted to the PCB 150, the blind-hole 128 of the second block 120 is still easily accessible, and frequency-tuning of the resonance cavity of the filter 100 may easily be performed by altering the dimensions of the blind-hole 128 and/or by removing e.g. at least part of a metallization provided on the surface of the blind-hole in order to alter a capacitance between the blind-and through-hole (s). For example, it is envisaged that the diameter and/or depth/height of the blind-hole 128 may be mechanically altered by using for example scraping or grinding, in which (ceramic) material is physically removed from e.g. the bottom and/or side surfaces of the blind-hole 128. As discussed earlier herein, this has the benefit that it allows to compensate for e.g. various material and/or manufacturing tolerances, and that the resonance frequency of the filter can thus still be altered to within specifications by the use of the blind-hole 128 and the variable dimensions thereof. Further, as the first and second blocks 110 and 120 may be manufactured individually before being attached together, the overall manufacturing process is made easier. For example, the through-hole 118 may be suitable for ceramic forming (and also metallization), and production yield and cost may both be improved, with a resulting improved consistency of density. In general, it is envisaged that e.g. scraping or grinding of the surface of the blind-hole may serve to remove e.g. a metallization present on such surface. This may alter a capacitance between the blind-and through-hole, and thereby provide frequency-tuning. It is envisaged e.g. that such scraping (or grinding) may be used e.g. during final assembly of the filter, or after the filter has been assembled, in a mass production process. Likewise, frequency-tuning may also be achieved by the altering of the dimensions of the blind-hole, e.g. as part of a manufacturing of the second ceramic block.

Another embodiment of a filter as envisaged herein will now be described with reference to FIG. 2.

FIG. 2 schematically shows an exploded view of a multi-pole filter 200. Just as for the various filters 100, 101 and 102 described with references to FIGS. 1A-1G, a multi-pole filter can be created by providing multiple through-and blind-holes in the respective first and second blocks of the filter. In the example shown in FIG. 2, the filter has a first block 210 and a second block 220. In order to create a five-pole filter, there are five through-holes 218a-e provided in the first block 210, and five corresponding blind-holes 228a-e provided in the second block 220. The through-holes 218a-e are distributed and spaced along a longitudinal direction L₁ of the filter 200, and the blind-holes 228a-e are aligned such that each of the blind-holes 228a-e at least partially aligns (or completely aligns) with a corresponding one of the through-holes 218a-e. To illustrate that the blocks 210 and 220 are not necessarily perfectly rectangular cuboids, the corners 217 and 227 of the first and second blocks 210 and 220, respectively, are here rounded, and there are also e.g. notches 229 provided on the first and second blocks 210 and 220, as usually done to couple multiple resonance cavities together to form a multi-pole filter.

Although being illustrated as having five through-holes and five blind-holes, a multi-pole filter as envisaged herein may of course also have other numbers of through-and blind-holes. For example, the number of through-holes may preferably match a number of desired poles of the filter, such that there is formed one resonance cavity for each pole (as the filter 200 may be thought of as multiple single-pole filters being connected in series). Additionally, the number of blind-holes may or may not necessarily match the number of through-holes. There may for example be one blind-hole for each through-hole, such that the resonance frequency of each resonance cavity may be tuned as discussed earlier herein. In other embodiments, one or more of the resonance cavities may be formed in a non-tunable way, by excluding their corresponding blind-holes such that there is a lower number of blind-holes than through-holes, etc. Additionally, depending on the desired tunability of the filter as a whole, one, few or all of the blind-holes may align completely with their respective through-holes, while the other blind-hole or blind-holes only partially align with their corresponding through holes. Similarly, the dimensions of the through-holes and the blind-holes, as well as the exact shape of the through-holes and blind-holes may all be configured as desired, and it may not necessarily be such that each through-and blind-hole pair is equally configured as the other pairs, and so on and so forth.

The filter 200 is further mounted to a PCB 250, such that a bottom surface (not shown) of the first block 210 faces towards a top surface 252a of the PCB (just as discussed earlier herein for the single-pole filter 100). Consequently, even if having multiple resonance cavities forming multiple poles, the filter 200 is still such that the blind-holes 228a-e are easily accessible for physical/dimensional modifications even when the filter 200 has already been (surface-) mounted to the PCB 250. In particular, this provides an easy way of individually tuning each resonance cavity of the multi-pole filter 200. The filter 200 also has input and output terminals (not shown), which are connected to input and output signal ports/connectors 290 and 292, respectively, provided on the PCB 250. The ports 290 and 292 allows for e.g. a signal cable to be connected in order to inject/extract an RF signal to be filtered into/from the filter 200.

Examples of envisaged such input and output terminals will now be described in more detail with reference also to FIG. 3.

FIG. 3 schematically illustrates a cross-section of an embodiment of a filter 300 as envisaged herein. The filter 300 is in this particular example a two-pole filter, and consequently has two through-holes 318a and 318b provided in the first block 310, and two corresponding blind-holes 328 and 238b provided in the second block 320. On the first block 310, there is provided an input terminal 330a and an output terminal 330b. The filter 300 is further mounted to a PCB 350 as described earlier herein.

An input port/connector 392a is provided on the PCB 350, and connected to the input terminal 330 of the filter 300 via a microstrip line 394a. An output port/connector 392b is also provided, but here mounted directly to a lateral side of the filter 300. The output port/connector 392b is connected to the output terminal 330b of the filter via a conductor 394b. The conductor 394b may for example form part of the output port/connector 392b, or similar.

FIG. 3 serves only to illustrate one particular example of how the input and output terminals 330a and 330b of the filter 300 may be configured and arranged. In other embodiments, it may e.g. be envisaged that both the input and output terminals 330a and 330b are configured such as the input terminal 330a shown in FIG. 3, and connected to respective input and output ports/connectors provided on the PCB via microstrip lines. In yet other embodiments, it may instead be envisaged that both of the input and output terminals 330a and 330b are instead configured such as the output terminal 330b shown in FIG. 3, with the respective input and output ports/connectors mounted directly to the filter 300 itself and not the PCB 350. In yet other embodiments, the situation may be a mirrored version of that shown in FIG. 3, such that e.g. the terminal 330b is the input terminal, while the terminal 330a is the output terminal, etc. In common to all such envisagable configurations, the input and output terminals are provided and arranged on the first block 310 of the filter 300, as the signal is supposed to be both injected into, and extracted from, the first block 310 and the one or more resonance cavities formed therein by the one or more through-holes of the first block 310.

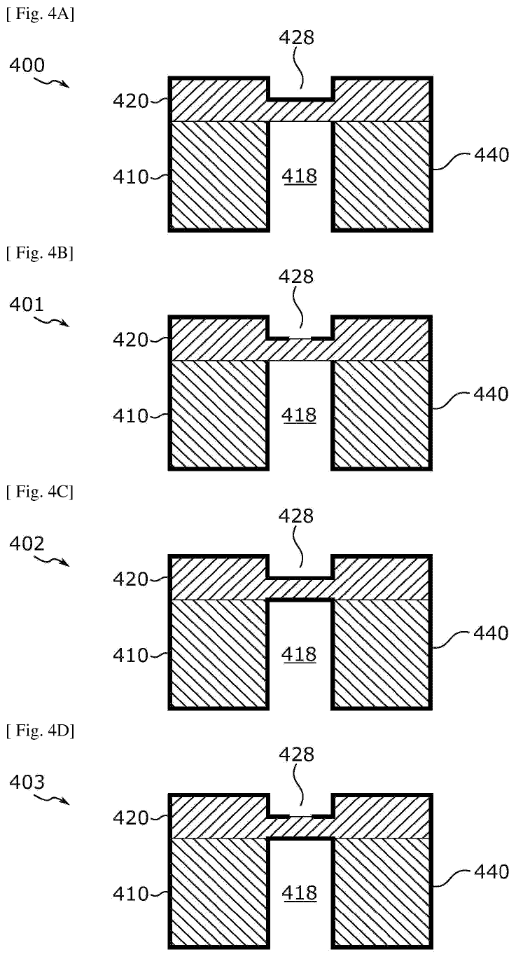

In order to form the one or more resonance cavities of a filter as envisaged herein, at least the outer surfaces of the filter are preferably metallized. Various examples of how such metallization can be performed will now be described in more detail with reference to FIGS. 4A-D, which each schematically illustrates a cross-section of an embodiment of a filter as described earlier herein.

FIG. 4A schematically illustrates a cross-section of one example of metallized surfaces, wherein a metallization layer 440 is provided on the bottom and side surfaces of the first block 410, on the top and side surfaces of the second block 420, as well as on all surfaces of the blind-hole 428 and on the side surfaces (e.g. inner walls) of the through hole 418. The metallization thus creates a closed metal cavity around the ceramic core, and in this particular embodiment the blind-hole 428 can be said to be fully/completely metallized while the top of the through-hole 418 is left without metallization.

FIG. 4B schematically illustrates a cross-section of another example of how to metallize the various surfaces of a filter 401. Here, the filter 401 is similar to the filter 400 described with reference to FIG. 4A, but with the bottom surface of the blind-hole 428 being only partially metallized. Processes for creating a metallization as shown in FIGS. 4A and 4B may for example be easier to perform and allow for improved quality control.

FIG. 4C schematically illustrates a cross-section of yet another example of a filter 402 similar to the filters 400 and 401, but wherein both the bottom of the blind-hole 428 as well as the top of the through-hole are fully metallized.

FIG. 4D finally schematically illustrates a cross-section of an example of a filter 403 similar to the filters 400, 401 and 402, but wherein the bottom of the blind-hole 428 is only partially metallized while the top of the through-hole 418 is fully metallized. Processes for creating a metallization as shown in FIGS. 4C and 4D may for example provide an improved frequency-tuning range and tuning sensitivity.

When “metallizing the top of the through-hole”, the metallization is preferably provided on the bottom surface of the second block 420 and such that, with the first and second blocks 410 and 420 attached to each other as described herein, the metallization on the bottom surface of the second block 420 aligns with the top opening of the through-hole 418.

In common to all examples of metallization is that the metallization process can be done separately for each of the first and second blocks 410 and 420, or after the first and second blocks 410 and 420 have been attached to each other. This allows for more flexibility in which ceramic manufacturing process to choose.

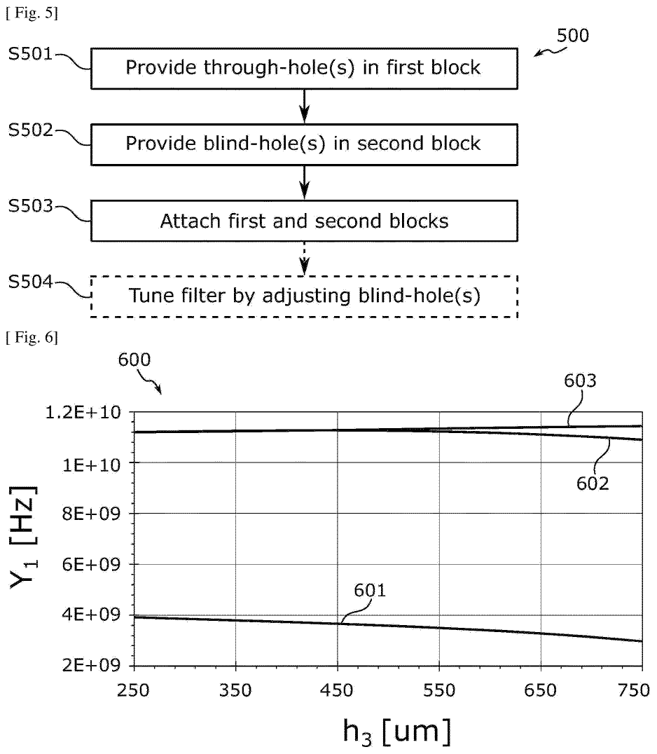

The present disclosure also envisages a method for manufacturing of the above-described filter, as will now be described in more detail with reference also to FIG. 5.

FIG. 5 schematically illustrates a flowchart of a method 500 for manufacturing a ceramic RF filter as envisaged herein, such as e.g. any one of the filters 100-102, 200, 300 and 400-403 described herein with reference to the corresponding Figures thereof.

In a first step S501, the method 500 includes providing the one or more resonance through-holes through the first block (wherein the first block, as shown herein already) has a top surface, a bottom surface and side surfaces. The one or more through-holes are provided such that they extend from the top surface and all the way to the bottom surface of the first block. This may be achieved by ceramic forming, including e.g. abrasive drilling or any other suitable technique commonly used for forming holes in ceramic materials.

In a second step S502, the method 500 includes providing the one or more blind-holes in the second block (wherein the second block, as shown herein already) has a top surface, a bottom surface, and side surfaces). The one or more blind holes are provided such that they do not extend all the way through the second block, but only from the top surface of the second block and only partially to the bottom surface of the second block. The blind-holes are further arranged such that when the second block is attached to (or at least on top of) the second block, and such that the bottom surface of the second block faces towards the top surface of the first block, each of the one or more blind-holes is at least partially aligned with a corresponding one of the one or more through-holes of the first block.

In a third step S503, the method 500 includes performing such an attaching of the second block to the first block, using e.g. sintering, bonding or soldering.

Optionally, the method 500 may also include a step S504 wherein a frequency-adjustment of the filter is performed by adjusting a depth and/or size of at least one of the one or more blind-holes (by using e.g. scraping or any other means of removing material from second block in order to change the dimensions of the blind-hole). In some embodiments, such a frequency-adjustment is performed after the first block has been surface-mounted with its bottom surface to a PCB, which may offer an improved flexibility in that the filter may be tuned as a last step of mounting the filter to the PCB.

The method 500 may of course also include one or more steps of metallizing one or more surfaces of the first and second blocks, as described earlier herein with reference to e.g. FIGS. 4A-D.

To validate the envisaged filter design, various simulations have been performed and the results thereof are shown in FIG. 6.

FIG. 6 schematically illustrates a plot 600 of how the (fundamental) first 601, and (harmonic) second 602 and third 603 eigenmodes of a single-pole/-cavity filter as envisaged herein change as a function of the depth (h₃, as illustrated in FIG. 1F) of the blind-hole. In FIG. 6, Y₁ corresponds to the frequency (in Hz) of the various eigenmodes of the filter. As can be seen in FIG. 6, the envisaged filter design provides a good frequency tunability by adjusting the depth h₃ of the blind-hole, and the second and third eigenmodes (harmonics) are more than around 310% of the fundamental eigenmode/center frequency of the simulated filter (i.e. with f₁/f₂=0.32).

To evaluate the performance of the envisaged filter design vis-à-vis conventional designs, such as various RF filters based on co-planar waveguides (CWGs), additional simulations have also been performed. The results of such simulations are shown in Table 1.

TABLE 1

| | Improved filter | CWG1 | CWG2 |
|---|---|---|---|
| εᵣ | 10 | 20 | 10 |
| f₁ (GHz) | 3.6 | 3.6 | 3.6 |
| V (mm³) | 288 | 288 | 595 |
| Qu | 1024 | 996 | 1332 |
| f₂ (GHz) | 11.2 | 7.1 | 8.9 |
| Qu/V | 3.56 | 3.46 | 2.24 |
| f₁/f₂ | 0.32 | 0.51 | 0.40 |

Table 1 illustrates simulation results for the envisaged filter design as well as for two other traditional CWG-based filter designs. In Table 1, er is the relative permittivity (or dielectric constant) of the filter material, f₁ is the fundamental frequency, V is the filter volume, Qu is the unloaded quality (Q) factor, f₂ is the first harmonic frequency, and Qu/V and f₁/f₂ indicate the corresponding “quality factor to volume” and “fundamental to harmonic frequency” (i.e. harmonic performance) ratios, respectively. There are two configurations of the CWG. The configuration “CWG₁” corresponds to a normally loaded CWG-structure having a same overall volume, but with a higher dielectric constant material than that of the improved filter design. The configuration “CWG₂” corresponds to a normally loaded CWG-structure having a same material, but instead with a larger overall volume than that of the improved filter design. For the improved design, the filter was assumed to have a length of 8 mm, a width of 8 mm, and a total height of 4.5 mm. The height of the first block was 3.5 mm, while the height of the second block was 1.0 mm. The diameter of the through-hole of the first block was 3.5 mm, and a loss tangent of the material used to create the first and second blocks was assumed to be 5.83e-5@3.5 GHz. As can be seen in FIG. 6, the depth of the blind-hole in the second block was varied between 0.25 and 0.75 mm, i.e. between 25 and 75% of the height of the second block. The dimensions of the monoblock used in the configuration “CWG₁” was the same as for the combination of the first and second blocks of the improved design, i.e. with a length of 8 mm, a width of 8 mm, and a height of 4.5 mm. In “CWG₁”, a single blind-hole was provided in the monoblock, with a diameter of 4.0 mm and a depth of 2.5 mm. A loss tangent of the material used for the monoblock was assumed to be 6.2e-5@3.5 GHz. The maximum f₁/f₂ for “CWG₁” of 0.51 was found by varying the depth of the blind-hole of “CWG₁” between 2.0 and 3.0 mm.

As made obvious by Table 1, the improved filter design provides both a better Qu and better harmonic performance (as indicated by f₁/f₂) compared with CWG₁, while maintaining a same volume V. The improved filter design also provides a better harmonic performance compared with CWG₂, while also reducing the overall volume. The improved design thus offers the best Qu/V and f₁/f₂ ratios of all three designs.

In summary of FIG. 6 and Table 1, and of the envisaged filter design (and method of manufacturing and optionally tuning thereof) of the present disclosure in general, it may be concluded that the envisaged design thus improves upon currently available technology by providing both a design wherein the frequencies of the filter may be easily tuned by changing e.g. the depth of the blind-hole, and wherein the blind-hole is easily accessible for such adjusting even when the filter is already mounted to a PCB. Additionally, the envisaged design also improves upon traditional designs by providing both an improved Qu/V ratio (indicating a higher quality factor at a reduce overall volume) as well as improved harmonic performance (as illustrated by the f₁/f₂ lower ratio, indicating that the harmonics are more separated from the fundamental frequency of the filter). The present disclosure thus satisfies the existing need for an improved filter design which allows for a small overall size, good performance, is easy to manufacture, and which may easily be tuned to account for material and manufacturing tolerances.

Although features and elements may be described above in particular combinations, each feature or element may be used alone without the other features and elements or in various combinations with or without other features and elements. Additionally, variations to the disclosed embodiments may be understood and effected by the skilled person in practicing the claimed invention as defined by the appended patent claims, from a study of the drawings, the disclosure, and the appended claims themselves. In the claims, the words “comprising” and “including” does not exclude other elements, and the indefinite article “a” or “an” does not exclude a plurality. The mere fact that certain features are recited in mutually different dependent claims does not indicate that a combination of these features cannot be used to advantage.

1. A ceramic radio frequency (RF), comprising:
a first ceramic block with a top surface, a bottom surface, and side surfaces, and with one or more resonance through-holes extending through the first ceramic block from its top surface to its bottom surface, and wherein the first ceramic block is configured for being surface-mounted with its bottom surface to a printed circuit board;
input and output terminals arranged at the first ceramic block and configured for injecting and extracting, respectively, a signal into/from the first ceramic block, and
a second ceramic block with a top surface, a bottom surface, and side surfaces, and with one or more blind-holes extending only partially through the second ceramic block from its top surface towards its bottom surface,
wherein the second ceramic block is attached on top of the first ceramic block with its bottom surface facing the top surface of the first ceramic block, and
wherein each of the one or more blind-holes of the second ceramic block is at least partially aligned with a corresponding one of the one or more through-holes of the first ceramic block.

2. The ceramic RF filter according to claim 1, wherein at least the side surfaces and the one or more through-holes of the first ceramic block, and the top surface and side surfaces of the second ceramic block, are metallized.

3. The ceramic RF filter according to claim 1, wherein the one or more blind-holes of the second ceramic block are at least partially metallized.

4. The ceramic RF filter according to claim 1, wherein the bottom surface of the second ceramic block is attached to the top surface of the first ceramic block by any one of bonding, sintering and soldering.

5. The ceramic RF filter according to claim 1, further comprising a metallization pattern on the top surface of the first ceramic block and/or on the bottom surface of the second ceramic block.

6. The ceramic RF filter according to claim 1, wherein a size (d₂) of each of the one or more blind-holes of the second ceramic block matches a size (d₁) of the corresponding through-hole of the first ceramic block.

7. The ceramic RF filter according to claim 1, wherein the size of at least one of the one or more through-holes of the first ceramic block is non-uniform along the length of the hole.

8. The ceramic RF filter according to claim 1, wherein the first and second ceramic blocks extend in a longitudinal direction (L₁), and comprise two or more through-holes and blind-holes, respectively, spaced along the longitudinal direction to form a plurality of resonators.

9. A method for manufacturing of a ceramic radio frequency (RF), comprising:
in a first ceramic block having a top surface, a bottom surface, and side surfaces, providing one or more resonance through-holes extending through the first ceramic block from its top surface to its bottom surface;
in a second ceramic block having a top surface, a bottom surface, and side surfaces, providing one or more blind-holes extending only partially through the second ceramic block from its top surface towards its bottom surface, such that if the second ceramic block is attached on top of the first ceramic block with its bottom surface facing the top surface of the first ceramic block, each of the one or more blind-holes is at least partially aligned with a corresponding one of the one or more through-holes of the first ceramic block, and
performing such an attaching of the second ceramic block on top of the first ceramic block.

10. The method according to claim 9, further comprising:
performing a frequency-adjustment of the ceramic RF filter by adjusting at least one of a depth (h₃) and size (d₂) of at least one of the one or more blind-holes of the second ceramic block.

11. The method according to claim 10, wherein the adjusting at least one of the depth and size of at least one of the one or more blind-holes of the second ceramic block is performed by scraping.

12. The method according to claim 10, wherein the frequency adjustment of the ceramic RF filter is performed after the first ceramic block has been surface-mounted with its bottom surface to a printed circuit board.

13. The method according to claim 9, further comprising performing a metallization of at least the side surfaces and the one or more through-holes of the first ceramic block, and the top surface and side surfaces of the second ceramic block.

14. The method according to claim 9, further comprising performing at least a partial metallization of the one or more blind-holes of the second ceramic block.

15. The method according to claim 9, wherein the attaching of the second ceramic block on top of the first ceramic block includes attaching the bottom surface of the second ceramic block to the top surface of the first ceramic block by any one of bonding, sintering and soldering.
